(19) United States
(12) Patent Application Publication
(10) Pub. No.: US 2025/0058610 A1
(43) Pub. Date: Feb. 20, 2025

(54) SLIDING DOOR STRUCTURE FOR VEHICLE

(71) Applicants: HYUNDAI MOTOR COMPANY, Seoul (KR); KIA CORPORATION, Seoul (KR); KWANGJIN CO., LTD., Asan-si (KR)

(72) Inventors: Jaeseung LEE, Hwaseong-si (KR); Jinsu JANG, Asan-si (KR); Taeyong JEON, Pyeongtaek-si (KR)

(21) Appl. No.: 18/738,157

(22) Filed: Jun. 10, 2024

(30) Foreign Application Priority Data
Aug. 17, 2023 (KR) 10-2023-0107543

(51) Int. Cl. B60J 5/08; E05D 15/10

(52) U.S. Cl. CPC B60J 5/08; E05D 15/101

(57) ABSTRACT

A sliding door structure for a vehicle includes a door configured to open and close an opening of a vehicle body, a door arm that connects the door to the vehicle body, a slider connected to an end of the door arm and slide-moved along a linear rail installed on the vehicle body, a hook disposed on the slider and rotated by the movement of the slider to rotate the door arm, a rotation pin disposed on the linear rail and rotating the hook by being coupled to or uncoupled from the hook when the slider is moved, a release button disposed on the slider and rotated in contact with the rotation pin when the slider is moved, and a gear lock in contact with the release button and rotated by the rotation of the release button to fix or release the rotation of the door arm.

### CROSS-REFERENCE TO RELATED APPLICATION

This application claims priority to and the benefit of Korean Patent Application No. 10-2023-0107543, filed in the Korean Intellectual Property Office on Aug. 17, 2023, the entire contents of which are incorporated herein by reference.

### TECHNICAL FIELD

The present disclosure relates to a sliding door structure for a vehicle, and more particularly, to a sliding door structure for a vehicle, in which an opening of a vehicle body is opened and closed by the door sliding back and forth in a length direction of the vehicle.

### BACKGROUND

A vehicle may have a cabin of a predetermined size where a driver or the driver's accompanying passenger may ride, and the vehicle body may be installed with a cabin opening/closing door to open and close the cabin.

In a case of a passenger car, the cabin opening/closing door may include a front door installed at the front of the vehicle in a length direction, and a rear door installed at the rear of the vehicle in the length direction. Here, the front door and the rear door may be usually installed on the vehicle body to be rotatable via hinges.

In a case of a van where many people ride together, the cabin opening/closing door may open and close the cabin while performing a sliding motion back and forth in the length direction of the vehicle.

The sliding-type cabin opening/closing door of the van may open the cabin by being moved backward in the length direction of the vehicle, and close the cabin by being moved forward in the length direction of the vehicle, thus having a smaller space required to open and close the door than a hinged cabin opening/closing door of the passenger car, for example, and completely opening the opening formed in the vehicle body even when a space required to open and close the door is narrow.

However, a conventional sliding-type compartment opening/closing door may have an excessive space where a door arm intrudes into a side sill part of the vehicle when opening/closing the door due to a fixed sliding door arm structure, thus requiring a floor height of the vehicle to be increased to secure this space. In some examples, due to its feature, the sliding door may have a limitation in maximizing a door open amount, and have an excessive door protrusion amount.

### SUMMARY

The present disclosure attempts to provide a sliding door structure for a vehicle that adopts the sliding door structure allowing a linear motion and a rotational motion by coupling a rotatable door to a slider slide-moved along a linear rail of the vehicle, thus expanding an opening width as well as minimizing a space where a door arm intrudes into a side sill part of the vehicle.

According to an implementation, provided is a sliding door structure for a vehicle, the structure including; a door opening and closing an opening part of the door that is formed in a vehicle body; a door arm having one end connected to the inside of the door and the other end connected to the vehicle body at the opening to be rotated and slide-moved; a slider connected to the other end of the door arm and slide-moved along a linear rail installed on the vehicle body; a hook disposed on the slider and rotated by the movement of the slider to rotate the door arm; a rotation pin disposed on the linear rail and rotating the hook by being coupled to or uncoupled from the hook when the slider is moved; a release button disposed on the slider and rotated in contact with the rotation pin when the slider is moved; and a gear lock in contact with the release button and rotated by the rotation of the release button to fix or release the rotation of the door arm.

The hook may be disposed on the slider and rotated around a hook pin passing through the slider.

The hook may have a hook opening having one open end and extending in a length direction, and the rotation pin may be inserted into or released from the hook opening.

A hook gear may be rotatably coupled to the hook pin, and the hook gear may be rotated together with the hook.

An arm gear may be disposed on the slider, and engaged with the hook gear to be rotated in a direction opposite to a rotation direction of the hook gear.

The arm gear may be disposed on the slider, and rotated around an arm gear pin passing through the slider.

Teeth engaged with the hook gear may be partially formed on an outer peripheral portion of the arm gear, a step may be formed on the outer periphery portion of the arm gear where the teeth are not formed, and the gear lock may be coupled to or uncoupled from the outer peripheral portion where the step is formed.

The gear lock may be disposed on the slider and rotated around a gear lock pin installed on the slider.

A gear lock spring may be disposed on an outer periphery of the gear lock pin and provide elasticity to the gear lock.

The release button may be disposed on the slider, and rotated around a release button pin installed on the slider.

A release button spring may be disposed on an outer periphery of the release button pin, and provide elasticity to the release button.

When the door is switched from a closed state to an open state, the slider may be moved in a length direction of the vehicle body, and a hook opening of the hook may be inserted into the rotation pin to rotate the hook, a hook gear may be rotated together with the hook, an arm gear may be rotated in engagement with the hook gear to rotate the door arm, and the arm gear may be engaged with and coupled to the gear lock to fix the arm gear and the door arm that are being rotated.

When the slider is moved further in the length direction of the vehicle body, the hook opening of the hook may be separated from the rotation pin, and the door may be slide-moved while the door arm is fixed.

A stopper may be installed at an end of the linear rail, and limit the movement of the slider when the stopper comes into contact with the slider.

When the door is switched from an open state to a closed state, as the slider is moved in a length direction of the vehicle body, the rotation pin may rotate the release button, the release button may rotate the gear lock to release coupling between the gear lock and an arm gear, a hook opening of the hook may be inserted into the rotation pin to rotate the hook, a hook gear may be rotated together with the hook, and the arm gear may be rotated in engagement with the hook gear to rotate the door arm.

According to an implementation of the present disclosure, adopted is the sliding door structure which may be fixed or released by coupling the rotatable door arm to the slider slide-moved along the linear rail of the vehicle, and having the door arm rotated as the hook of the slider and the rotation pin of the linear rail are coupled to or uncoupled from each other to thus eliminate the amount of intrusion into the vehicle body interior by the door arm, thereby implementing the flat structure of the vehicle body, thus reducing the height (or step height) of the vehicle body.

In some examples, the sliding door structure may implement the linear motion and the rotational motion of the door to thus maximize the door opening width and improve the freedom of layout and interior design.

### BRIEF DESCRIPTION OF THE DRAWINGS

FIG. 1 is a view showing an example of a door of a sliding door structure for a vehicle that is closed.

FIG. 2 is a view showing an example state where the door of the sliding door structure is being opened.

FIG. 3 is a view showing am example state where the door of the sliding door structure is completely opened.

FIGS. 4A to 4D are views each showing an example operation of components based on movement of a slider when opening the door of the sliding door structure.

FIGS. 5A to 5D are views each showing in detail an example of a rotation relationship between a hook gear and an arm gear when opening the door of the sliding door structure.

FIGS. 6A to 6D are views each showing in detail an example of a rotation relationship between the hook gear and the arm gear when closing the door of the sliding door structure.

FIG. 7 is an exploded perspective view showing example components of the sliding door structure.

### DETAILED DESCRIPTION

Hereinafter, implementations of the present disclosure are described in detail with reference to the accompanying drawings so that those skilled in the art to which the present disclosure pertains may easily practice the present disclosure. The present disclosure may be implemented in various different forms and is not limited to the implementations provided herein.

In some examples, components having the same configuration will be representatively described using the same reference numerals in an implementation, and only components different from those of an implementation will be described in the other implementations.

Hereinafter, a sliding door structure for a vehicle is described in detail with reference to the accompanying drawings.

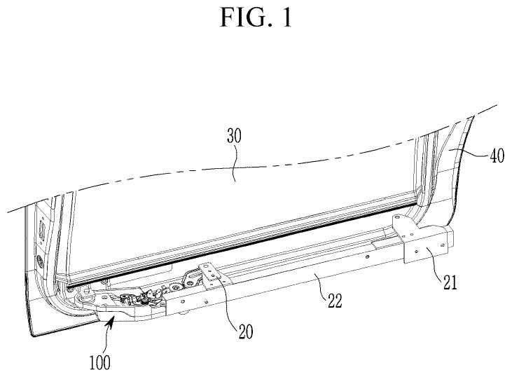

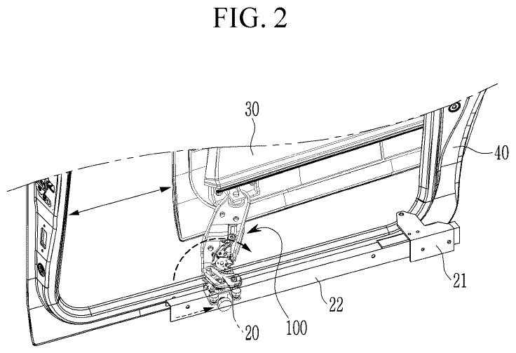

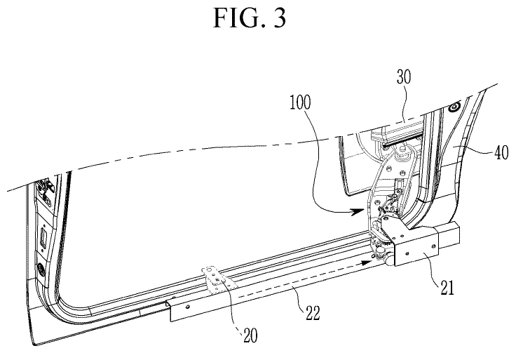

FIG. 1 is a view showing a state where a door of a sliding door structure for a vehicle has yet to be opened; FIG. 2 is a view showing a state where the door of the sliding door structure for a vehicle is being opened; and FIG. 3 is a view showing a state where the door of the sliding door structure for a vehicle is completely opened.

In some implementations, the sliding door structure 100 for a vehicle may be applied to a lower side of a door 30 installed at the rear of the vehicle in a length direction, and applied to a structure where the door 30 is opened and closed by movement of the vehicle in inner and outer directions or slide-movement of the vehicle back and forth in the length direction of the vehicle. In some examples, the sliding door structure for a vehicle may be applied to the lower side of the door 30 not only installed at the rear of the vehicle, but also installed in the front of the vehicle.

In some implementations, referring to FIGS. 1 to 3, the sliding door structure for a vehicle may include the door 30, a door arm 12, and a slider 8.

For instance, the door 30 may open and close an opening part of the door 30 that is formed in a vehicle body 40 of the vehicle, and the door arm 12 may be connected to the door 30 and the vehicle body 40. The door arm 12 may have one end connected to the inside of the door 30 and extending toward a side sill of the vehicle body 40. In some examples, the door arm 12 may have the other end connected to the vehicle body 40 at the opening to be rotated and slide-moved. The door arm 12 may have the other end connected to a lower side of the vehicle body 40 where the opening is formed by the slider 8.

The slider 8 may be connected to the other end of the door arm 12, and slide-moved along a linear rail 22 installed on the vehicle body 40. As the slider 8 is slide-moved along the linear rail 22, the door arm 12 connected thereto may be rotated, and as the door arm 12 is rotated, the door 30 connected to one end of the door arm 12 may be slide-moved while being rotated to the outside of the vehicle body 40.

In some examples, a stopper 21 may be disposed at an end of the linear rail 22, and limit the movement of the slider 8. The stopper 21 may be made of an elastic material such as rubber to relieve impact occurring when the stopper comes into contact with the slider 8.

In some examples, a rotation pin 20 may be disposed on the linear rail 22 and function to rotate the door arm 12 by being in contact with the slider 8 when the slider 8 is moved. A hook 1 may be disposed on the slider 8 in order for the door arm 12 to be rotated, and the hook 1 may be rotated in contact with the rotation pin 20 as the slider 8 is moved to rotate the door arm 12.

In some examples, a gear lock 4 and a release button 6 may be disposed on the slider 8 to fix or release the rotation of the door arm 12 based on the movement of the slider 8. Operations of the rotation pin 20, the hook 1, the gear lock 4, and the release button 6 are described below.

As shown in FIGS. 1 to 3, a state of the door 30 may be changed from a state where the door has yet to be opened to the state where the door is being opened. The slider 8 may then be moved toward the rear of the vehicle along the linear rail 22, and the hook 1 disposed on the slider 8 may thus be in contact with the rotation pin 20 disposed on the linear rail 22, thus causing the hook 1 to be rotated.

As the hook 1 is rotated, the door arm 12 may be rotated and the door 30 connected to one end of the door arm 12 may be slide-moved while being rotated to the outside of the vehicle. When rotated at a predetermined angle, the door arm 12 may stop the rotation, and the slider 8 may be slide-moved along the linear rail 22 until the slider 8 comes into contact with the stopper 21, thus completely opening the door 30.

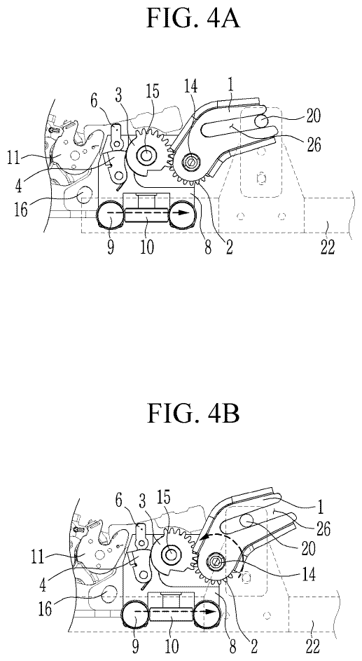

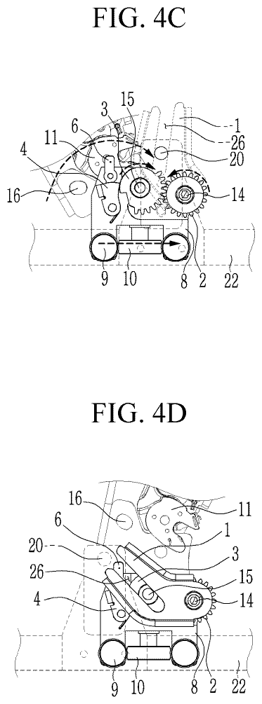

FIGS. 4A to 4D are views each showing an operation of each component based on the movement of the slider when opening the door of the sliding door structure for a vehicle.

Referring to FIGS. 4A to 4D, the sliding door structure for a vehicle may include: the hook 1 disposed on the slider 8 and rotated by the movement of the slider 8 to rotate the door arm 12; the rotation pin 20 disposed on the linear rail 22 and rotating the hook 1 by being coupled to or uncoupled from the hook 1 when the slider 8 is moved; the release button 6 disposed on the slider 8 and rotated in contact with the rotation pin 20 when the slider 8 is moved; and the gear lock 4 in contact with the release button 6 and rotated by the rotation of the release button 6 to fix or release the rotation of the door arm 12.

As shown in FIG. 4A, a roller 9 may be disposed on the slider 8, and the slider 8 may be moved along the linear rail 22 by the roller 9. The hook 1 may be rotatably disposed on one side of slider 8, and the hook 1 may come into contact with the rotation pin 20 as the slider 8 is moved. The hook 1 may be disposed on the slider 8 to be rotated around a hook pin 14 passing through the slider 8, and the hook 1 may have a hook opening 26 having one open end and extending in the length direction. The rotation pin 20 may be inserted into or released from the hook opening 26. The rotation pin 20 may be fixed to the linear rail 22. Therefore, as the slider 8 is moved, the hook opening 26 may be inserted into the rotation pin 20 to rotate the hook 1.

As shown in FIG. 4B, the hook 1 may start to be rotated when the rotation pin 20 is inserted into the hook opening 26 and the slider 8 is moved further. A hook gear 2 may be coupled to the hook pin 14 so that the hook gear may be rotated around the same axis as a rotation axis of the hook 1, and the hook gear 2 may be rotated together with the hook 1.

In some examples, an arm gear 3 may be disposed on the slider 8, engaged with the hook gear 2 to be rotated in a direction opposite to a rotation direction of the hook gear 2, and rotated around an arm gear pin 15 passing through the slider 8.

Teeth engaged with the hook gear 2 may be partially formed on an outer peripheral portion of the arm gear 3, and a step may be formed on the outer periphery portion of the arm gear 3 where the teeth are not formed. The gear lock 4 may be coupled to or uncoupled from the outer peripheral portion where the step is formed. The gear lock 4 may be rotated around a gear lock pin 27 installed on the slider 8, and a gear lock spring 5 may be disposed on an outer periphery of the gear lock pin 27 and provide a force for the gear lock 4 to be in continuous contact with a side surface of the arm gear 3.

In some examples, the release button 6 may be in contact with the gear lock 4, and the gear lock 4 may be rotated by the rotation of the release button 6 when the rotation pin 20 comes into contact with the release button 6 to rotate the release button 6. The release button 6 may be rotated around a release button pin 28 installed on the slider 8, and a release button spring 7 may be disposed on an outer periphery of the release button pin 28, and provide elasticity for the release button 6 to return to its original position after the rotation.

As the arm gear 3 is rotated, the door arm 12 may start to be rotated to the outside of the vehicle body 40 and the door 30 may start to protrude outward from the vehicle body 40.

As shown in FIGS. 4C and 4D, as the slider 8 is moved further and the hook 1 and the hook gear 2 are rotated, the arm gear 3 may be engaged with the teeth of the hook gear 2 to be rotated in the direction opposite to the rotation direction of the hook gear 2. When the rotation pin 20 is in contact with the release button 6, the gear lock 4 may be rotated by the release button 6, and the gear lock 4 may be coupled to the outer peripheral portion of the arm gear 3 that is being rotated where its step is formed. When the gear lock 4 is coupled with the step of the arm gear 3, the rotations of the arm gear 3, the hook gear 2, and the hook 1 may be stopped, and the rotation pin 20 is released from the hook opening 26. In some examples, the door 30 may be stopped while protruding outward from the vehicle body 40, and in this state, the door 30 may be slide-moved in the length direction of the vehicle body 40.

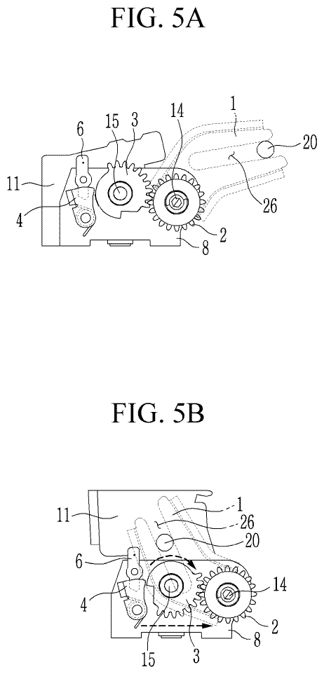

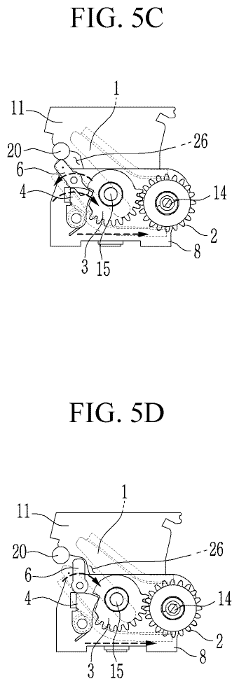

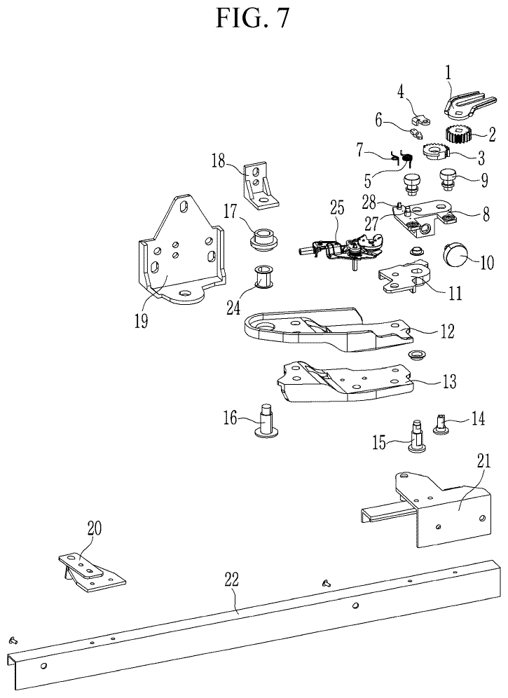

FIGS. 5A to 5D are views each showing in detail the rotation relationship between the hook gear and the arm gear when opening the door of the sliding door structure for a vehicle; and FIG. 7 is an exploded perspective view showing a component part of the sliding door structure for a vehicle.

Referring to FIGS. 5A to 5D and 7, when the slider 8 is moved along the linear rail 22, the rotation pin 20 may start to be inserted into the hook opening 26 (see FIG. 5A). When the slider 8 is moved further, the rotation pin 20 may be inserted deeper into the hook opening 26 to rotate the hook gear 2. As the hook gear 2 is rotated, the arm gear 3 engaged with the hook gear 2 may be rotated in the direction opposite to the rotation direction of the hook gear (see FIG. 5B). In this case, the door arm 12 connected to the arm gear 3 may be rotated to the outside of the vehicle body 40, and the door 30 may start to protrude outward from the vehicle body 40.

When the slider 8 is moved further, the rotation pin 20 may come into contact with the release button 6, and the release button 6 may be rotated to rotate the gear lock 4. The gear lock 4 may be inserted into the outer peripheral portion of the arm gear 3 where the teeth are not formed to stop the rotation of the gear lock 4 and also stop the rotation of the hook gear 2 (see FIG. 5C). In this case, the door 30 may have a maximum amount of protrusion outward from the vehicle body 40.

When the slider 8 is moved further, the contact between the rotation pin 20 and the release button 6 may be released, and the release button 6 may return to its original position by the elasticity of the release button spring 7 disposed on the outer periphery of the release button pin 28. In some examples, the rotation pin 20 may be separated from the hook opening 26, and the door 30 may be slide-moved while protruding outward from the vehicle body 40, thereby opening the door 30.

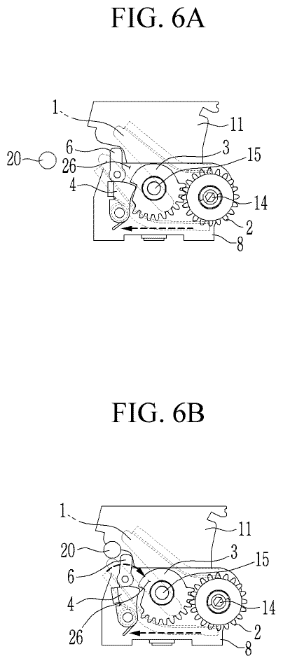

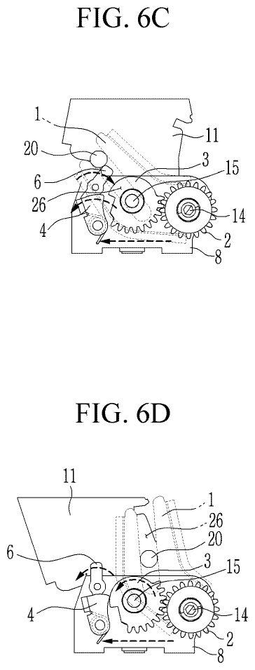

FIGS. 6A to 6D are views each showing in detail the rotation relationship between the hook gear and the arm gear when closing the door of the sliding door structure for a vehicle.

Referring to FIGS. 6A to 6D and 7, the slider 8 may be slide-moved by starting to be moved along the linear rail 22 in a direction opposite to its movement direction when the door 30 is opened (see FIG. 6A), and this slide-movement may cause the rotation pin 20 to come into contact with the release button 6 (see FIG. 6B). The release button 6 may be rotated by its contact with the rotation pin 20, and simultaneously, the rotation pin 20 may start to be inserted into the hook opening 26 (see FIG. 6B).

As the slider 8 is moved further, the rotation pin 20 may further rotate the release button 6, and the gear lock 4 may be rotated by the rotation of the release button 6, thus releasing the coupling between the gear lock 4 and the arm gear 3. As the rotation pin 20 is inserted deeper into the hook opening 26, the hook 1 and the hook gear 2 may be rotated, and the rotation of hook gear 2 may cause the rotation of the arm gear 3 engaged with the hook gear 2 (see FIG. 6C). As the arm gear 3 is rotated, the door arm 12 connected to the arm gear 3 may turn to be closer to the vehicle body 40, and the door 30 may be moved toward the vehicle body 40 and start to be closed.

When the slider 8 is moved further, the release button 6 may return to its original position by the elasticity of the release button spring 7, and the hook gear 2 and the arm gear 3 may be further rotated for the door arm 12 connected to the arm gear 3 to turn to be as close as possible to the vehicle body 40, and the door 30 may thus be completely closed (see FIG. 6D).

As set forth above,, adopted is the sliding door structure which may be fixed or released by coupling the rotatable door arm to the slider slide-moved along the linear rail of the vehicle, and having the door arm rotated as the hook of the slider and the rotation pin of the linear rail are coupled to or uncoupled from each other to thus eliminate the amount of intrusion into the vehicle body interior by the door arm, thereby implementing the flat structure of the vehicle body, thus reducing the height (or step height) of the vehicle body.

In some examples, the sliding door structure may implement the linear motion and the rotational motion of the door to thus maximize the door opening width and improve the freedom of layout and interior design.

Although the implementations of the present disclosure have been described hereinabove, the scope of the present disclosure is not limited thereto, and all equivalent modifications easily modified by those skilled in the art to which the present disclosure pertains are intended to fall within the scope and spirit of the present disclosure.

What is claimed is:

1. A sliding door structure for a vehicle, the sliding door structure comprising:
a door configured to open and close an opening of a vehicle body, the door being configured to laterally move relative to the vehicle body;
a door arm configured to rotate relative to the door and the vehicle body, the door arm having (i) a first end connected to an inside of the door and (ii) a second end connected to the vehicle body;
a slider connected to the second end of the door arm and laterally moved along a linear rail disposed at the vehicle body;
a hook disposed at the slider and configured to be rotated by a movement of the slider to thereby rotate the door arm;
a rotation pin disposed at the linear rail and configured to be coupled to or uncoupled from the hook based on the movement of the slider to thereby rotate the hook;
a release button disposed at the slider and configured to, based on the movement of the slider, contact the rotation pin and rotate relative to the slider; and
a gear lock configured to contact the release button and be rotated by rotation of the release button to thereby restrict or release rotation of the door arm.

2. The sliding door structure of claim 1, further comprising a hook pin that passes through the slider, and
wherein the hook is configured to rotate around the hook pin.

3. The sliding door structure of claim 2, wherein the hook defines a hook opening that extends from an open end of the hook in a length direction, and
wherein the rotation pin is configurd to be inserted into or released from the hook opening.

4. The sliding door structure of claim 3, further comprising a hook gear rotatably coupled to the hook pin, the hook gear being configured to rotate together with the hook.

5. The sliding door structure of claim 4, further comprising an arm gear disposed at the slider and engaged with the hook gear, the arm gear being configured to rotate in a direction opposite to a rotation direction of the hook gear.

6. The sliding door structure of claim 5, further comprising an arm gear pin that passes through the slider,
wherein the arm gear is configured to rotate around the arm gear.

7. The sliding door structure of claim 5, wherein the arm gear comprises:
teeth defined at a first part of an outer peripheral portion of the arm gear and engaged with the hook gear; and
a step defined at at second part of the outer periphery portion of the arm gear where the teeth are not defined, and
wherein the gear lock is coupled to or uncoupled from the second part of the outer peripheral portion of the arm gear.

8. The sliding door structure of claim 1, further comprising a gear lock pin disposed at the slider,
wherein the gear lock is disposed at the slider and configured to rotate around the gear lock pin.

9. The sliding door structure of claim 8, further comprising a gear lock spring that is disposed at an outer periphery of the gear lock pin and configured to provide elasticity to the gear lock.

10. The sliding door structure of claim 1, further comprising a release button pin disposed at the slider,
wherein the release button is configured to rotate around the release button pin.

11. The sliding door structure of claim 10, further comprising a release button spring that is disposed at an outer periphery of the release button pin and configured to provide elasticity to the release button.

12. The sliding door structure of claim 10, wherein the slider is configured to move in a length direction of the vehicle body to thereby switch the door from a closed state to an open state,
wherein the hook defines a hook opening and a hook gear,
wherein the rotation pin is configured to, based on the slider moving in the length direction of the vehicle body to open the door, insert into the hook opening to thereby rotate the hook,
wherein the hook gear is configured to rotate together with the hook,
wherein the sliding door structure further comprises an arm gear that is configured to engage with and rotate with the hook gear to thereby rotate the door arm, and
wherein the arm gear is configured to engage with and coupled to the gear lock to thereby restrict rotation of the arm gear and the door arm.

13. The sliding door structure of claim 12, wherein the rotation pin is configured to be separate from the hook opening based on the slider moving further in the length direction of the vehicle body, and
wherein the door is configured to slide relative to the vehicle body while the door arm is fixed.

14. The sliding door structure of claim 1, further comprising a stopper disposed at an end of the linear rail and configured to limit the movement of the slider based on the stopper coming into contact with the slider.

15. The sliding door structure of claim 10, wherein the slider is configured to move in a length direction of the vehicle body to thereby switch the door from an open state to a closed state,
wherein the rotation pin is configured to rotate the release button based on the slider moving in the length direction of the vehicle body to close the door,
wherein the release button is configured to, based on the rotation pin rotating the release button, rotate the gear lock to thereby release coupling between the gear lock and an arm gear,
wherein the hook defines a hook opening and a hook gear,
wherein the rotation pin is configured to, based on the release button rotating the gear lock, insert into the hook opening to thereby rotate the hook, and
wherein the arm gear is configured to, based on rotation of the hook, engage with and rotate with the hook gear to thereby rotate the door arm.
